(19) United States
(12) Patent Application Publication
(10) Pub. No.: US 2025/0272783 A1
(43) Pub. Date: Aug. 28, 2025

(54) GRAPHICS TEXTURE RECONSTRUCTION

(71) Applicant: QUALCOMM Incorporated, San Diego, CA (US)

(72) Inventors: Farzad FARHADZADEH, San Diego, CA (US); Qiqi HOU, San Diego, CA (US); Hoang Cong Minh LE, Santee, CA (US); Amir SAID, San Diego, CA (US); Fatih Murat PORIKLI, San Diego, CA (US)

(21) Appl. No.: 18/649,690

(22) Filed: Apr. 29, 2024

Related U.S. Application Data
(60) Provisional application No. 63/562,148, filed on Mar. 6, 2024.
(60) Provisional application No. 63/557,998, filed on Feb. 26, 2024.

(51) Int. Cl. G06T 3/4007; G06T 15/04

(52) U.S. Cl. CPC G06T 3/4007; G06T 15/04; G06T 2210/36

(57) ABSTRACT

Certain aspects of the present disclosure provide techniques for reconstructing a texel of a texture. Such techniques may include receiving a plurality of sets of features corresponding to the texture, wherein the plurality of sets of features comprises a respective set of features for each respective grid point of a grid; receiving coordinate information corresponding to the texel of the texture; receiving level of detail information; selecting a subset of grid points of the grid based on the second resolution being lower than the first resolution; sampling one or more grid points from among the subset of grid points based on the coordinate information to obtain sampled features associated with the one or more grid points; inputting, to a machine-learning model, the sampled features; and receiving, from the machine-learning model, based on the sampled features, a reconstruction of the texel of the texture at the second resolution.

### CROSS-REFERENCE TO RELATED APPLICATIONS

This application claims the benefit of and priority to U.S. Provisional Patent Application No. 63/557,998, filed on Feb. 26, 2024, and U.S. Provisional Patent Application No. 63/562,148, filed on Mar. 6, 2024, the entire contents of which are hereby incorporated by reference.

### INTRODUCTION

### Field of the Disclosure

Aspects of the present disclosure relate to computer vision, and more particularly, to techniques for performing graphics texture reconstruction.

### DESCRIPTION OF RELATED ART

Techniques for compressing and reconstructing graphics textures have applications in various fields, including video gaming, virtual reality, and special effects rendering. Specifically, being able to efficiently compress textures while still retaining the ability to reconstruct the textures at multiple resolutions and randomly access texture data is desirable in the field of graphic reconstruction. This allows more textures to be stored and streamed efficiently while still providing the necessary access patterns for rendering complex 3D scenes.

For example, techniques have been introduced to store precomputed texture pyramids that contain multiple resolutions of textures. While this allows direct access to different resolutions, these techniques require large storage overhead. Alternative techniques have relied on parameterized “grids” that are optimized during training to contain latent representations of textures across resolutions. However, these grid-based techniques require storing grids at multiple resolutions expressly for handling texture decoding at desired resolutions.

To provide random access capabilities for rendering, grid-based techniques often rely on specialized decoding architectures that can randomly sample texture data from grids. However, these decoder architectures are constrained to operate on grids of predetermined resolutions. Techniques have not sufficiently decoupled the decoding resolution from set grid resolutions to enable more flexible decoding from compressed latent spaces.

Moreover, existing learning-based approaches require jointly optimizing decoder parameters along with data representations encoded within grids. These approaches can be computationally intensive. Improved techniques that have lower optimization overhead while still providing the necessary decoding flexibility remain desirable.

### SUMMARY

One aspect provides a method for reconstructing a texel of a texture. In certain aspects, the method may include receiving a plurality of sets of features corresponding to the texture, wherein the plurality of sets of features comprises a respective set of features for each respective grid point of a grid, wherein each respective grid point of the grid is associated with a respective portion of the texture, wherein the grid has a first resolution; receiving coordinate information corresponding to the texel of the texture; receiving level of detail information indicating a second resolution at which to reconstruct the texture, wherein the second resolution is lower than the first resolution; selecting a subset of grid points of the grid based on the second resolution being lower than the first resolution; sampling one or more grid points from among the subset of grid points based on the coordinate information to obtain sampled features associated with the one or more grid points; inputting, to a machine-learning model, the sampled features; and receiving, from the machine-learning model, based on the sampled features, a reconstruction of the texel of the texture at the second resolution.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts details of a graphics texture reconstruction system, in accordance with examples of the present disclosure.

FIG. 2A depicts a block diagram of an exemplary training process for a graphics texture reconstruction system in accordance with aspects of the present disclosure.

FIG. 2B depicts an example grid in accordance with aspects of the present disclosure.

FIG. 3 depicts additional details of an encoder of the graphics texture reconstruction system in accordance with aspects of the present disclosure.

FIG. 4 depicts additional details of a decoder of the graphics texture reconstruction system in accordance with aspects of the present disclosure.

FIG. 5 illustrates an example artificial intelligence (AI) architecture that may be used for AI-enhanced wireless communications.

FIG. 6 illustrates an example AI architecture of a first wireless device that is in communication with a second wireless device.

FIG. 7 illustrates an example artificial neural network.

FIG. 8 depicts an example method for performing a graphics texture reconstruction.

FIG. 9 depicts aspects of an example device.

### DETAILED DESCRIPTION

Aspects of the present disclosure provide apparatuses, methods, processing systems, and computer-readable mediums for performing a graphics texture reconstruction. In certain aspects, the graphics reconstruction may be machine-learning (ML) based, such as neural-based.

More specifically, certain aspects are directed to methods for compressing textures and/or using the compressed textures to reconstruct the textures as part of graphics rendering, such as for applications involving rendering in graphic arts, gaming, and virtual reality environments. A texture may be a representation of a material that is rendered on an object in an environment. For example, an environment may include a wall, and the wall may be meant to represent a brick wall. Accordingly, a brick texture may be rendered on a surface of the wall to give the appearance of a brick wall.

As compared to digital image compression and reconstruction, texture compression and reconstruction has a number of additional challenges. In particular, digital image compression and reconstruction deals with compressing an image at a resolution and using the compressed image to reconstruct that entire image at the same resolution. In contrast, graphics textures may need to be rendered at different resolutions (e.g., MIP or MIPMAP levels, where the letters in MIP stand for the Latin phrase, multum in parvo, meaning much in little), and further only a portion of the texture may need to be rendered, thereby requiring random-access to the texture. For example, different portions/views of an environment may need to be rendered based on a changing view to be rendered of the environment, such as due to user input changing a portion and/or zoom level of an environment that is to be displayed. Based on the portion/view of the environment to be displayed and/or zoom level, a different portion of a texture at a different resolution may need to be rendered on a surface of an object. Further, a given texture may be formed from a number of different layers/components of the texture depending on the material, requiring a number of layers to be rendered for a single texture. Accordingly, a texture may be formed from a texture set, wherein the texture set is a set of components/layers of the texture, such as a diffuse component, a normal component, a roughness component, a subsurface component, etc.

As discussed, there is a technical problem in graphics texture compression and reconstruction where current techniques require storing texture data across multiple resolutions expressly for handling texture decoding at other desired resolutions. This storage incurs high storage and computational overhead.

Aspects herein provide techniques for graphics reconstruction that may not require storing texture data across multiple resolutions. Such techniques may provide a technical solution to the discussed technical problem, and may provide a technical benefit in terms of reduced storage requirements and computational overhead. For example, aspects described herein provide techniques where an encoder is used to generate a compressed latent representation of a texture as a “grid” of feature sets. This grid may be sampled during decoding to reconstruct textures at multiple resolutions without having predetermined texture pyramid levels.

In certain aspects, the encoder can be configured to output feature sets at a fixed grid resolution, regardless of the texture content or target reconstruction resolutions. For example, the grid resolution may match the highest resolution of texture to be compressed. In certain aspects, during decoding, striding techniques can be used to sample this fixed grid at different rates to produce varying output resolutions. This provides flexibility without needing multiple grid resolutions expressly for handling different texture resolutions.

### Example Graphics Texture Reconstruction System

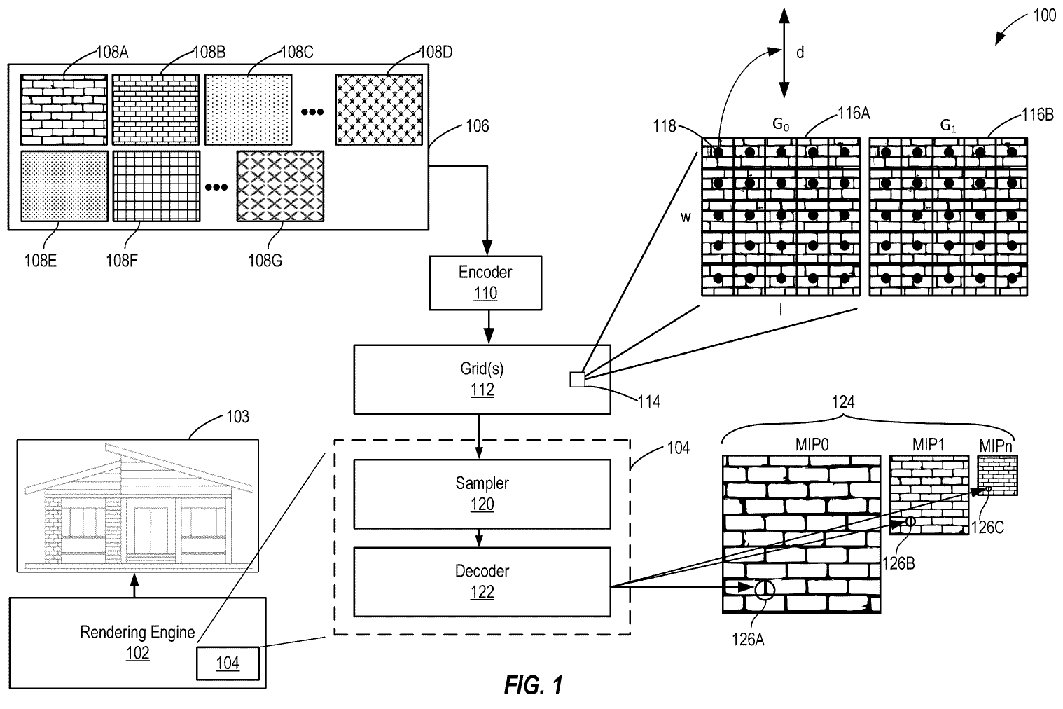

FIG. 1 depicts details of a graphics texture reconstruction system 100 according to aspects of the present disclosure. As depicted in FIG. 1, the graphics texture reconstruction system 100 may include a rendering engine 102 configured to render graphics utilizing one or more textures that can be displayed at the display device (103) and/or integrated into various images stored on a processing system. In certain aspects, the rendering engine 102 can render portions of textures at varying resolutions, for instance, at different MIP levels. In certain aspects, it could be necessary to render only specific portions of a texture, thereby requiring random-access to texture data needed for graphics rendering. For example, based on user inputs that alter the view or zoom level of a displayed or to-be rendered environment, various sections or perspectives of the environment could be rendered to reflect changes in the scene being displayed or rendered. Accordingly, based on the portion/view of the environment to be displayed or rendered and/or zoom level, a different portion of a texture at a different resolution may need to be rendered on a surface of an object.

In accordance with aspects of the present disclosure, the rendering engine 102 may include a texture engine 104 configured to provide the portion of the texture needed for rendering to the rendering engine 102. In examples, the portion of the texture provided by the texture engine 104 may correspond to a texel, or a fundamental unit of texture. In certain aspects, a texture may comprise a texture set 106, where a texture set 106 comprises groups of related texture components/layers 108 that represent different material properties of a texture. A texel refers to the specific value at a given location within each of the components/layers 108. For example, one example texture set 106 may correspond to a brick texture that the rendering engine 102 maps onto a surface of a wall in a rendered environment. The brick texture set 106 may comprise components/layers 108 representing different attributes of the brick that are used by rendering engine 102 to render the appearance of the brick. These components/layers 108 may include, but are not limited to, a diffuse component 108A containing color/albedo information, a roughness component 108B containing spatial roughness variation information, a bump or normal component 108C containing simulated bump/normal details for lighting calculations, a displacement component 108D containing depth details for mesh displacement, a subsurface scattering component 108E containing parameters related to simulated light diffusion under the surface, an ambient occlusion component 108F containing precalculated ambient occlusion shadows, and/or additional components 108G related to other aspects of the brick material appearance and/or behavior. The different components/layers 108 of the texture set 106 allow the rendering engine 102 to render a more realistic and visually rich rendering of 3D objects. That is, the different components/layers 108 allow the rendering engine 102 to render various material properties and behaviors under different lighting conditions corresponding to the real-world brick material.

As storing and accessing texture sets 106 at different resolutions may be resource intensive (e.g., requiring a large amount of storage resources to store components/layers 108 for each texture set 106 in a rendering), in certain aspects, the texture engine 104 is configured to reconstruct texture information from compressed texture information stored in one or more grid(s) 112. In certain aspects, to facilitate the compressed storage of the texture sets 106, the graphics texture reconstruction system 100 utilizes an encoder 110 configured to generate compressed representations of texture sets 106 such that the compressed representations of texture sets 106 can be stored as one or more grid(s) 112. In some aspects, the encoder 110 utilizes a machine-learning architecture, such as a neural network architecture, such as but not limited to a convolutional autoencoder architecture including convolutional layers and downsampling layers. In certain aspects, encoder 110 may output a reduced latent space representation of the texture set 106 in the form of grid(s) 112. More particularly, the encoder 110 may be configured to receive a texture set 106, and output one or more grid(s) 112 of features corresponding to components/layers 108 of texture set 106. The grid(s) 112 allow reconstruction of texture sets 106 at varying resolutions, while utilizing less storage than would otherwise be required to store multiple resolutions of texture sets 106.

A grid may include a set of grid points corresponding to a grid resolution, such as 2×2 grid points. Each grid point may be representative of a portion (referred to herein as a “tile”) of the original texture. For example, the original texture may be divided into a set of tiles corresponding to the number of grid points of the grid. In an example, the original 1024×1024 texture may be divided into 2×2 tiles, such that each tile corresponds to 512×512 texels of the original texture. Each grid point may then represent one of the 512×512 texel tiles. Each grid point may correspond to a set of features associated with the tile associated with the grid point, and a location (e.g., an index) of the grid point within the grid. Each feature of the set of features for a grid point may represent a combination of one or more different types of texture components/layers 108 of the texture set 106. The number of features per grid point may be, for example, 32, and each feature may be referred to as a channel. Each feature may represent the tile as a whole of the original texture, and not just a particular texel of the tile. Accordingly, a grid may include a plurality of sets of features, each grid point of the grid including a respective set of features. As used herein, the term “set” may refer to one or more, unless stated otherwise for a particular case. As used herein, the term “subset” may refer to less than all of a “set.” Accordingly, where a subset of a set is referred to, the set necessarily may include a plurality of elements, and the subset less than all of the plurality of elements.

As another example, grid(s) 112 may correspond to a storage location for a plurality of grid(s) for a plurality of texture sets 106. An example grid 114 may include a first grid G0 116A corresponding to a plurality of components/layers 108 of the texture set 106. In an example, the first grid G0 116A may be a 128×128 grid (e.g., 1=128, w=128) that includes 128×128 grid points 118. Assuming the source texture set 106 has a resolution of 1024×1024, each grid point 118 represents an 8×8 texel tile of the source texture set 106, such that the full first grid G0 116A represents the entire texture set 106 in a compressed 128×128 representation. In some examples, each grid point 118 of first grid G0 116A may be represented as a d-dimensional tensor, where d is equal to the number of features per grid point. In some aspects, a texture set 106 may be represented using a single grid (e.g., first grid G0 116A).

In certain aspects, the output features from encoder 110 may be separated into multiple grids (e.g., 116A and 116B) associated with a texture set 106. That is, each grid (e.g., 116A, 116B) may include different features of the sets of features. For example, each set of features at each grid point may include 48 features. In certain aspects, grid G0 116A may comprise 16 channels per grid point 118, while grid G1 116B may comprise 32 channels per grid point. The multiple grids 116A and 116B may have the same resolution (e.g., share their corresponding tile regions) such that grid G0 116A and grid G1 116B together represent the full texture set 106 in a compressed form. In certain aspects, while FIG. 1 depicts two-dimensional grids for clarity, one or more grid(s) 114 may comprise tensors of three or higher dimensions, with grid points 118 arranged in matching multidimensional patterns. The grid structure depicted in FIG. 1 may allow random access during decoding to reconstruct a texel corresponding to a texture set.

The texture engine 104 may include a sampler 120 and a decoder 122. In certain aspects, the sampler 120 is configured to sample one or more grid(s) 112 to extract features from grid points 118 that correspond to regions of interest of the texture set 106 for decoding. In certain aspects, the sampler 120 may receive location information indicating a region of interest of the texture set 106 for decoding. In addition, the sampler 120 may receive level of detail information indicating a desired resolution at which to reconstruct a texel. In some examples, the rendering engine 102 may provide the location information and the level of detail information to the sampler 120. Based on the level of detail information and the location information, the sampler 120 may select a subset of grid points from one or more grid(s) 114 (e.g., 116A and/or 116B) and sample the subset of grid points utilizing a sampling algorithm (e.g. nearest neighbor, bilinear sampling, bicubic sampling, etc.) to obtain sampled features associated with the one or more grid points. In some aspects, the sampled features associated with the one or more grid points correspond to interpolated grid point features for a desired texture region.

In certain aspects, the decoder 122 is configured to reconstruct texels from the compressed grid representations 114 using the sampled features associated with the one or more grid points sampled by sampler 120. In certain aspects, the decoder 122 utilizes a machine-learning model to reconstruct a texel based on the sampled features associated with the one or more grid points sampled by sampler 120, the level of detail information, and the location information. The decoder 122 may be configured to reconstruct texels for a plurality of resolutions 124. Thus, in certain aspects, the decoder 122 can reconstruct a texel 126A at a first resolution (e.g., MIP0). Alternatively, or in addition, the decoder 122 can reconstruct a texel output 126B at a second resolution (e.g., MIP1). As another example, the decoder 122 can reconstruct a texel 126C at another resolution (e.g., MIPn). One or more of the resolutions (e.g., MIP0, MIP1, MIPn) may be greater than, equal to, or less than a resolution of the texture set 106. In addition, one or more of the resolutions (e.g., MIP0, MIP1, MIPn) may be less than another of the resolutions (e.g., MIP1 may be less than MIP0, MIPn may be less than MIP1).

The rendering engine 102 may receive the reconstructed texel (e.g., 126A) from the decoder 122 and use the reconstructed texel (e.g., 126A) to render an image, for example an image displayed at the display device 103. In some aspects, the rendering engine 102 may include the texture engine 104. Alternatively, or in addition, a texture engine 104 may be separate from the rendering engine 102. While resolutions MIP0, MIP1, and MIPn were depicted in FIG. 1, it should be understood that the decoder 122 may reconstruct texels at resolutions different from that, which is shown. In addition, a texture set 106 may include additional or fewer components/layers 108 than that which is illustrated in FIG. 1. Further, grid(s) 112 and grids 116A/116B may be of different resolutions than previously described.

### Example Graphics Texture Reconstruction System Training

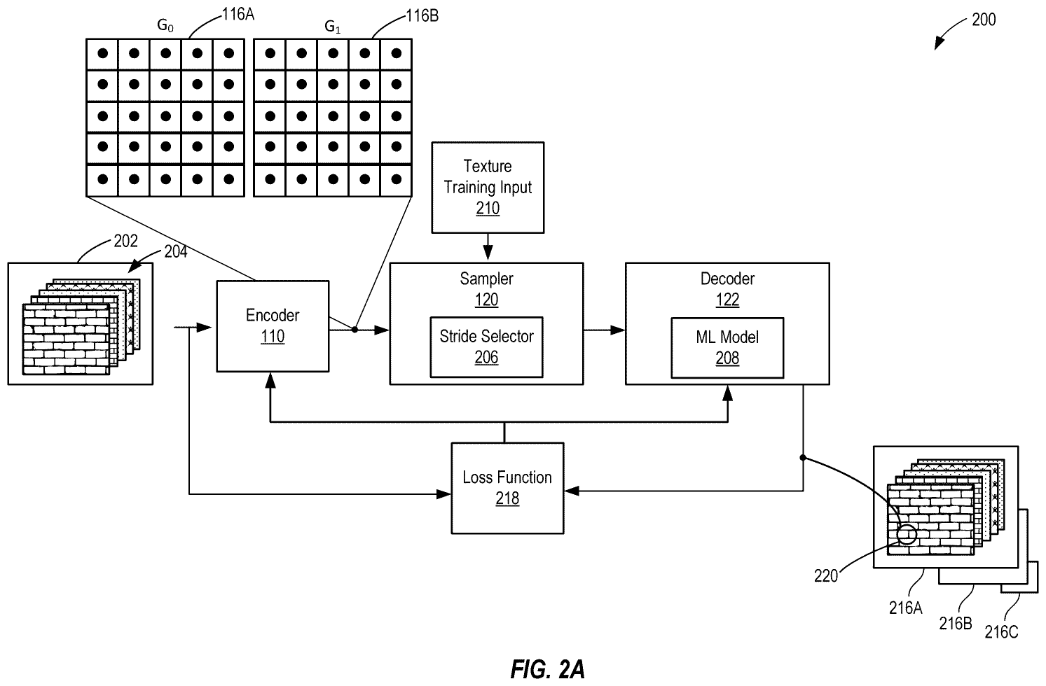

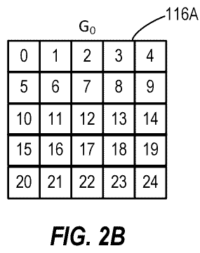

FIG. 2A depicts a block diagram of an exemplary training process 200 for a graphics texture reconstruction system 100 according to aspects of the present disclosure. As described with respect to FIG. 1, in some aspects, the encoder 110 and the decoder 122 utilize machine-learning components to encode a texture set and decode sampled grid points to reconstruct a texel. FIG. 2A depicts an exemplary training process 200 for training the encoder 110 and the decoder 122 to improve texture set compression and texel reconstruction accuracy when processing texture sets 106.

In some aspects, and as depicted in FIG. 2A, the training process 200 includes providing one or more source texture sets 202 including a plurality of components/layers 204 to train the encoder 110 and the decoder 122. The encoder 110, such as described with respect to FIG. 1, receives an input texture set 202 and outputs latent space representations in the form of one or more grid(s) 116A, 116B comprising a respective set of features for each respective grid point of the one or more grid(s) 116A, 116B. In certain aspects, each respective grid point of the grid is associated with a respective portion of the input texture set 202. The encoder 110 trains under the guidance of a loss function 218 to output the grids (e.g., 116A, 116B) representing compressed versions of input texture set 106.

The training process 200 enables the decoder 122 to reconstruct texels (e.g., 220) from grids 116A, 116B at multiple resolution levels, including full resolution MIP 0 (e.g., 216A) down to lower resolution MIP n levels (e.g., 216C). Thus, in certain aspects, the sampling of each of the one or more grids (116A, 116B) is based on a (e.g., predicted) resolution to render the texel. For example, where the resolution to render the texel is lower than a resolution of a grid, the grid may be sampled by excluding (also referred to as striding) certain grid points while sampling. For example, where the resolution to render the texture is 64×64, while the resolution of the grid is 128×128, instead of using all the grid points of the grid for sampling, every other grid point in every other row of the grid may be used for sampling. For example, the nearest four grid points out of every other grid point in every other row of the grid to the particular coordinate may be sampled.

Where the resolution to render the texture is greater than or equal to the resolution of the grid, the entire grid may be used for sampling. Where the resolution to render the texture is less than the resolution of the grid, a subset of grid points may be selected for sampling. The subset of grid points selected for sampling may be based on a stride level, where the stride level may be based on a ratio between the resolution to render the texture, and the resolution of the grid. For example, if the resolution to render the texture is 2×2, and the resolution of the grid is 6×6, the stride level may be 3 (e.g., 6/2).

As an example illustration of striding, an example grid 116A is shown in FIG. 2B, with numbers representing grid points. As shown, such grid 116A is illustrated as having 5×5 grid points, numbered from 0-24. Given a stride level of 2, the first grid point included in the subset may be grid point 0, and each additional grid point included in the subset is determined by adding the stride level to the previous selected grid point for the subset until the end of the grid is reached, such that the additional grid points included in the subset would be 2, 4, 6, 8, 10, 12, 14, 16, 18, 20, 22, and 24. A stride level of 3 may give the following grid points in the subset: 0, 3, 6, 9, 12, 15, 18, 21, 24. A stride level of 5 may give the following grid points in the subset: 0, 5, 10, 15, 20.

Thus, as part of the training, a texture training input 210 may indicate a level of detail that provides resolution level inputs indicating a MIP level to target for each training iteration. This MIP level guides the stride selector 206 in configuring sampling strides for sampler 120. The texture training input 210 may additionally indicate location information corresponding to a region for texel reconstruction. Thus, the sampler 120 provides sampled grid features, and optionally location information, to the decoder 122. In certain aspects, the decoder 122 utilizes a machine-learning model 208, for example a multilayer perceptron, to reconstruct a texel 220 for the location and resolution indicated by the level of detail and resolution level indicated in the texture training input 210 using the sampled grid features.

As training progresses, the loss function 218, calculating differences between the decoder 122 reconstructed texel 220 and an original sample of the texture set 202, drives the adjustment of machine-learning model weights within decoder 122 to iteratively reduce reconstruction errors across one or more MIP levels 216A, 216B, 216C. Additionally, the encoder 110 weights may be updated through the backpropagation of the decoder 122 errors to further optimize the grids generated by the encoder 110. In this manner, coordinated training of the encoder 110 and the decoder 122 enables texture compression and reconstruction at multiple resolutions, while storing textures in the compact grid representations (e.g., 116A, 116B).

An example of the loss function is below:

$$Loss ( x , y ) = {( {D}_{θ} ( {E}_{ϕ} ( T ) ) ( x , y ) - T ( x , y ) )}^{2} \\ θ := θ - λ \frac{\partial L}{\partial θ} \\ ϕ := ϕ - λ \frac{\partial L}{\partial ϕ}$$

Here, θ represents the weights of the decoder, ϕ represents the weights of the encoder, D_{θ}(E_{ϕ}(T)) (x, y) represents the texel output of the decoder, operating with weights θ, for coordinate (x, y) of the texture using the texture as input to the encoder, operating with weights ϕ, and T(x, y) represents the actual texel at coordinate (x, y). During training, the encoder 110 and decoder 122 are run many times, with different texture training inputs 210, to output reconstructed texels at different resolutions of the texture, and at different coordinates, and using the loss function 218 to adjust the weights of a machine-learning model implemented by the encoder 110 and the machine-learning model implemented by the decoder 122. The encoder 110 and decoder 122 weights, accordingly, may be trained specifically for a given texture set 202, such that different texture sets are associated with different weights. In other aspects, the encoder 110 and decoder 122 may be trained across multiple textures, such that multiple textures are associated with the same weights.

In certain aspects, the encoder 110 and the decoder 122 can be trained to support multiple sampling algorithms for constructing the localized grid feature inputs using a sampler configuration of the sampler 120. For example, as training progresses, the sampler 120 may vary sampling techniques such as nearest neighbor, bilinear, and bicubic sampling to account for different modes of sampling. In some examples, the different sampling modes may be based on the texture set 202, a desired compression level, a grid resolution, etc.

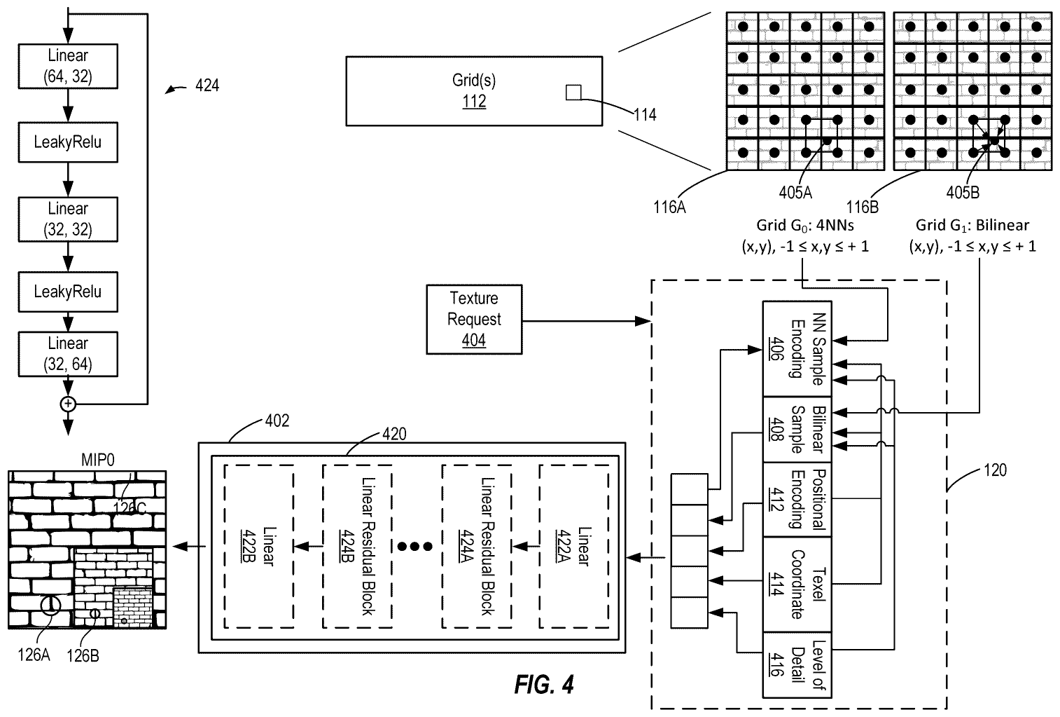

In some aspects, the encoder 110 and the decoder 122 are trained in multiple stages. For example, when utilizing a texture set T, an initial portion of the texture set may be randomly cropped to a size of 256×256. Subsequently, the cropped texture set can be passed to the encoder 110, followed by one or more grid constructors (e.g., as further described in FIG. 4 below) that facilitate the construction of a corresponding grid pair Gᵢ (e.g., 116A and 116B of FIG. 1).

In certain aspects, the encoder 110 and the decoder 122 are trained jointly using an alternating process. For example, in a first phase, the weights of the encoder 110 may be held fixed, while the weights of the decoder 122 can be updated based on gradients of the loss function 218 with respect to the decoder weights. In certain aspects, this can allow the decoder 122 to adapt to the current output of the encoder 110 and improve its reconstruction of the input texture. In certain aspects and during a second phase, the weights of the decoder 122 may be held fixed, while the weights of the encoder 110 can be updated based on the gradients of the loss function 218 with respect to the encoder weights, which may be obtained by backpropagating the gradients through the decoder 122. In certain aspects, this allows the encoder 110 to adapt its output (e.g., the intermediate grid and feature information) to improve the reconstruction quality of the fixed decoder 122. Such an example training process can alternate between the two phases over many iterations. In each iteration, the encoder 110 can process the input texture to generate the intermediate grid and feature information, which can then be used by the decoder 122 to reconstruct the texture. The loss function 218 can compare the reconstructed texture to the original input texture, and the gradients may be computed with respect to both the decoder weights (in the first phase) and the encoder weights (in the second phase).

For texel reconstruction, a MIP level in proportion to the area of the randomly cropped MIP level can be randomly selected. In examples, this random selection is achieved by sampling from an exponential distribution with a rate parameter λ=log 4. To address an issue related to undersampling low-resolution MIP levels, a percentage (e.g., 10%) of the training batches can randomly select a MIP level from a uniform distribution spanning an entire chain of MIP levels, helping to ensure a more balanced representation across different resolution levels during training. In one or more subsequent training stages, the crop-size Cs can be increased by a factor (e.g., a factor of 2) until the decoder 122 is capable of reconstructing a complete chain of MIP levels. Thus, in some examples, the training can utilize a batch size of, for example, 4 and a learning rate (LR) of, for example, 10⁻⁴, which can be decreased by a factor of (e.g., 2) as the crop size is incremented at each stage. At a final stage, the model can be trained for, for example, 20,000 steps with a LR of, for example, 10⁻⁵.

In some aspects, and during earlier training stages, additive uniform noise within a range of

$$( - \frac{1}{{2}^{{B}_{i} + 1}} , \frac{1}{{2}^{{B}_{i} + 1 ,}} ) ,$$

where Bᵢ is a desired number of bits allocated to store each element of the grid, can replace quantization. However, during a final training stage, feature values can be quantized using a straight-through estimator (STE) to enforce a fixed quantization rate of Bᵢ=4, i=0, 1 for all feature values in a grid pair Gᵢ.

In some aspects, the bits-per-pixel-per-channel (BPPC) encompassing both the bits required to allocate a grid-pair and parameters specific to the decoder, which is trained uniquely for each texture set, can be measured. Where Bᵢ=4 for storing each grid-pair Gᵢ (where i=0, 1), a total number of bits needed to store the grid-pair is given by

$$\frac{{c}_{{g}_{i} \cdot h \cdot w}}{32} ,$$

where c_{g}_{ᵢ} represents the number of channels of the grid Gᵢ and h×w denotes the resolution of the texture set. Additionally, a total number of bits required to store the decoder corresponds to the total number of parameters in the decoder, multiplied by the parameter precision. To control the bit rate, the number of channels in the grid pair c_{g}_{ᵢ} can be changed, as can the size and number of hidden layers in one or more of the encoder 110 or decoder 122.

In certain aspects, the encoder 110 can be an autoencoder configured to compress the input texture into a latent representation, which may include the plurality of sets of features corresponding to the grid points. The decoder 122 can be configured to reconstruct the texel from the latent representation. The training process for the autoencoder can include performing multiple iterations across multiple MIP levels of the input texture. In some aspect, during each iteration, the input texture at a specific MIP level may be processed by the encoder 110 to generate a latent representation. The latent representation may then be used by the decoder 122 to reconstruct the texels at a same MIP level. The reconstructed texels can then be compared to the original texels using a loss function (e.g., loss function 218), and the gradients of the loss may be backpropagated through the decoder 122 and encoder 110 to update their respective weights.

In certain aspects, the autoencoder can be trained using a progressive approach, starting from the highest MIP level (i.e., the lowest resolution) and moving to lower MIP levels (i.e., higher resolutions). This allows the autoencoder to first learn coarse-grained features of the texture at low resolutions and then progressively refine the details at higher resolutions. In some aspects, the training process may involve additional techniques such as adversarial training, where a discriminator model can be used to provide additional feedback to the autoencoder to improve the realism of the reconstructed texels. In some aspects, the autoencoder may be trained using perceptual loss functions that compare high-level features extracted from the reconstructed and original texels using a pre-trained neural network.

### Example Encoder for a Graphics Texture Reconstruction System

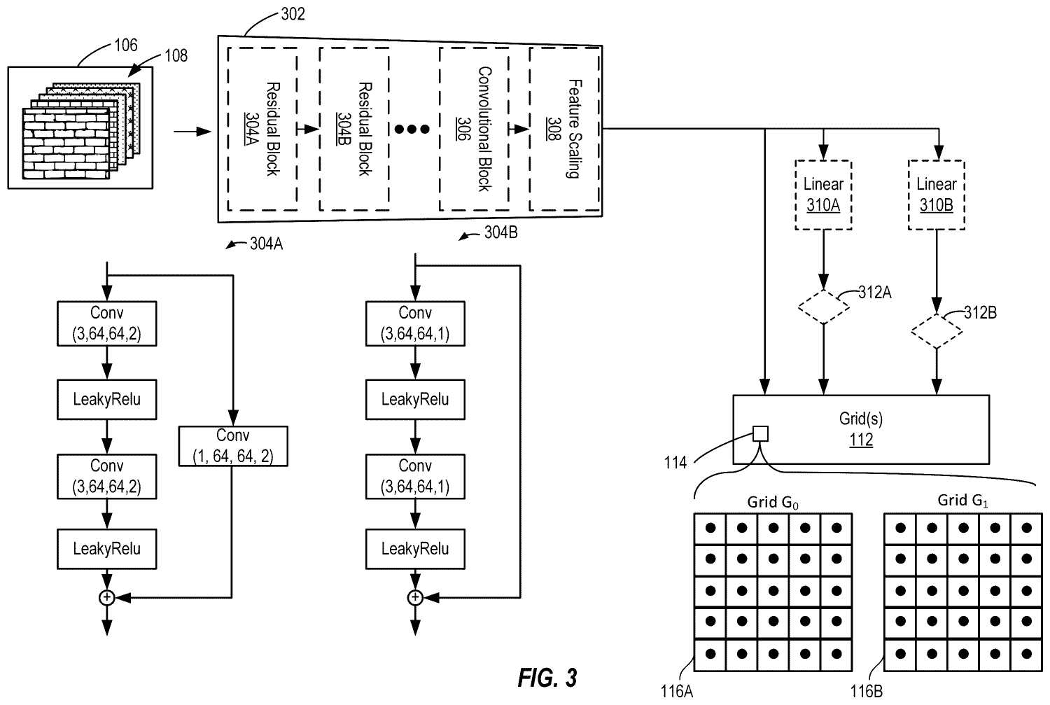

FIG. 3 depicts details of an example encoder (e.g., encoder 110 of FIG. 1). In certain aspects, the encoder may implement an autoencoder neural network architecture including encoder and decoder sub-components trained jointly to generate compressed intermediate grid representations of input texture sets.

As described in FIGS. 1-2, a trained encoder 302 (e.g., corresponding to a component of encoder 110 of FIG. 1) may include one or more machine-learning components that undergo the training process 200 to generate features stored as grid points corresponding to portions of texture sets. In certain aspects, the trained encoder 302 includes optional residual blocks 304A-304B, an optional convolutional block 306, and an optional feature scaling block 308 to construct the compact latent space grid representations (e.g., 116A, 116B) corresponding to an input texture set 106. In certain aspects, the residual blocks 304A and 304B feature skip connections that enhance the training of deep neural networks. That is, the residual connections may transmit information more directly across different layers, improving information flow and accelerating training. In certain aspects, residual blocks 304A and 304B may include one or more Conv layers and one or more LeakyRelu layers as depicted in FIG. 3. In additional aspects, encoder 302 applies activation functions, such as feature scaling using a hyperbolic tangent function, after one or more convolutional blocks 306 prior to pooling/downsampling. This scaling and normalization of feature maps may provide a bound to the range of feature values to aid subsequent optional linear quantization (e.g., 310A/312A and 310B/312B, which in certain aspects may be components of encoder 110 of FIG. 1) into discrete levels during compression. For example, the feature scaling block 308 may bound values between predefined ranges, for example between −0.5 and 0.5. This scaling and normalization of feature maps enables subsequent scalar quantization blocks 312A-312B to quantize the grid feature values to discrete levels during compression. The combined use of residual blocks 304A, 304B and feature scaling block 308 may enhance the compression efficiency when compressing the texture set(s) 106 into one or more grid representations. Each of the grids (e.g., grid 116A and grid 116B) may be stored at a storage location storing one or more grid(s) 112.

In some aspects, the encoder 302 (e.g., ε_{ϕ}(T)) may map a texture set T E [0,1]^{c×h×w} to a bottleneck latent representation Z∈[−0.5,0.5]^{c}^{_{z}}^{×h}^{_{z}}^{×w}^{_{z}}, such that ε_{ϕ}(T)=Z. The encoder 302 may generate a bottleneck-latent Z having a resolution that is downscaled by a factor of, for example, 8, e.g., h_{z}=h/8 and w_{z}=w/8, and bound into a subspace [−0.5,0.5]^{c}^{_{z}}^{×h}^{_{z}}^{×w}^{_{z}} by applying ½ tanh at a last layer of the encoder 302. In some examples, the input of the encoder is the texture set T of resolution h×w, since texture sets corresponding to MIP levels down to a resolution of, for example, 4×4, T^{m} ∈[0,1]^{c×h/2}^{^{m}}^{×w/2}^{^{m}}, 0≤m≤M=log₂ max (h, w)−2, are made by down-scaling T, where such information is included in the texture set T.

In some aspects, the blocks 310A/310B may be referred to as grid constructors C_{ζ0} and C_{ζ1} that map bottleneck latent Z to grids-pair G₀ 116A and G₁ 116B, where C_{ζi}(Z)=Gᵢ, i=0,1. In some aspects, Grid Gᵢ is a tensor of size c_{g}_{ᵢ}×h_{z}×w_{z} storing quantized features to reconstruct texture sets for various MIP levels. In some examples, grid constructors C_{ζi} may be linear projection [symbol] _{ζ}_{ᵢ} and scaler quantizer Qᵢ, where 312A/312B may correspond to such sealer quantizers. Thus, Cᵢ(Z)=(Qᵢ∘ [symbol] ᵢ)(Z)=Gᵢ. To quantize features of grid Gᵢ, Qᵢ represents an asymmetric scalar quantization of range

$$[ - \frac{{2}^{{B}_{i}} - 1}{{2}^{{B}_{i}} + 1} , \frac{1}{2} ] ,$$

where Bᵢ is a desired number of bits allocated to store each element of Gᵢ.

### Example Decoder for a Graphics Texture Reconstruction System

FIG. 4 depicts details of selecting, sampling, and decoding aspects of the graphics texture reconstruction system 100 according to aspects of the present disclosure. As described with respect to FIGS. 1-2, the texture engine 104 of graphics texture reconstruction system 100 includes a trained decoder that can reconstruct texels from latent space grid representations (e.g., grid 114), at varying target resolutions.

In certain aspects, the sampler 120 operates by initially receiving a texture request 404 from a rendering engine 102 (as depicted in FIG. 1). The rendering engine 102 (FIG. 1) may output requests to sample and reconstruct portions of stored texture sets (e.g., grid(s) 112) at desired locations and resolutions during graphics rendering. The texture request 404 indicates parameters that guide appropriate reconstruction, including coordinate information of a particular texel at a particular coordinate of the texture to be reconstructed, and desired level of detail information indicating a resolution, e.g., MIP level, at which to reconstruct the texel (e.g., 126A, 126B, 126C). The coordinate information and the desired level of detail information may be provided to sampler 120.

In certain aspects, the sampling process to obtain sampled grid features may be guided based on information indicated in the initial texture request 404 from rendering engine 102 (FIG. 1). For example, based on the indicated level of detail 416, a selector (e.g., stride selector 206 of FIG. 2A) may select a subset of grid points in one or more grid(s) 112, to be sampled, using striding as discussed. For example, when reconstructing lower resolution outputs, the stride selector 206 of FIG. 2A may sparsely identify grid points at wider intervals using striding, instead of densely selecting grid points at every point.

Sampler 120 may map the coordinate information to the grid space of grid(s) 112, such as grids 116A and 116B. For example, the tile including the texel (e.g., 405A, 405B), and corresponding grid point, indicated by the coordinate information may be identified.

In certain aspects, the grid points of grid(s) 112, such as the selected subset of grid points, may be sampled. In certain aspects, the sampler 120 performs sampling such as nearest neighbor sampling and/or bilinear sampling utilizing the grid points, such as the subset of grid points, to obtain one or more features or input (e.g., nearest neighbor sample 406 and/or bilinear sampling 408) into trained decoder 402 (e.g., an example of decoder 122 of FIG. 1) to reconstruct the texel. For example, in nearest neighbor sampling, the sampler 120 may identify the four nearest grid points in grid(s) 112 (e.g., of the subset of grid points) to the texel (e.g., 405A, 405B) indicated by the coordinate information, and obtain the features sets of such identified grid points for input into trained decoder 402. In bilinear sampling, the sampler 120 may identify the four nearest grid points in grid(s) 112 (e.g., of the subset of grid points) to the texel (e.g., 405A, 405B) indicated by the coordinate information, and generate a weighted average of the features sets of such identified grid points, weighted based on the distance of the texel from each of the identified grid points, to obtain a weighted average feature set for input into trained decoder 402.

In certain aspects, the sampler 120 may output sampled grid point feature(s) as grid feature vector(s) from one or more grid(s) 112 as a localized representation of the texture set focused on a region of interest, as in the texel to be reconstructed. The decoder 402 may utilize the input features to reconstruct the texel.

In some aspects, given coordinate (x, y) of MIP level m, a grid sampler S₀(G₀|x, y, m) (e.g., implemented as 120) locates the surrounding voxels and concatenates the c_{g}_{₀} dimensional features stored at each corner of a voxel and outputs Y₀. Grid sampler S₁(G₁|x, y, m) (e.g., implemented as 120) similarly finds surrounding voxels but linearly interpolates the c_{g}_{₀} dimensional features stored at each corner of the voxel according to the relative position of (x, y) within the voxel and outputs Y₁. In this way, G₀ can capture more detailed features of the texture set while G₁ captures more abstract information.

In examples, and as previously discussed, rather than having multiple grid-pairs of different resolutions for each subset of MIP levels, a single resolution grid-pair may be used. That is, to account for MIP levels m, m>3 that have lower resolution than the grid-pair Gᵢ, i−0,1, sampling can be performed with strides s=2^{m-3}; thus, after locating the top-left corner of the surrounding voxel, the additional voxel corners are chosen with stride s with respect to the located top-left corner.

In certain aspects, optionally, additional one or more inputs are input into the trained decoder 402, such as one or more of the level of detail 416, texel coordinate 414 corresponding to the coordinate information of texture request 404, or position encoding information 412, which may enhance reconstruction of the texel. Position encoding information 412 may represent the position of the particular texel coordinate within the tile represented by the grid point corresponding to the sampled features. The position encoding information 412 may be a value of a function using the particular coordinate as input, the value representing the position of the particular coordinate within the tile represented by the grid point. In some examples, the positional encoding information 412 may correspond to a specific (x,y) coordinate location in the texture space that is mapped, or encoded, into a position vector representing the target reconstruction location of the texel in the grid space. The decoder 402 may further have been trained with such additional one or more inputs.

In some aspects, and as depicted in FIG. 4, the trained decoder 402 utilizes the sampled grid features from grid sampler 120, optionally together with one or more of level of detail 416, position encoding information 412, and/or coordinate 414 to produce a reconstructed texel output 126 (e.g., 126A-126C). Though the architecture for decoder 402 can vary, in certain aspects the decoder 402 includes a neural network structure (e.g., 420) to infer required texture details from the limited grid input features. As one example, the decoded input features are first processed by an initial dense neural network layer 422A to expand the limited features into higher dimensions. Next, one or more residual linear layers 424A and 424B allow propagating signals deeper into the decoder network for increased reconstruction accuracy. In some examples, a residual linear layer 424 may include one or more linear layers and one or more leakyRelu layers as depicted in FIG. 4. Skip connections combine feature outputs from multiple decoder layers to preserve both local and global texture characteristics. Finally, linear output layers 422B condense the higher dimensional interim decoder output down into the texel feature dimensions needed to match the texel properties (e.g., size of reconstructed texel). The architecture depicted in FIG. 4 allows the decoder 402 to transform the sampled grid feature inputs into full-reconstructed texel output 126A, 126B, or 126C depending on a MIP level received in the texture request 404.

In some aspects, the trained decoder 402 maps a concatenation of grids samples Y₀ and Y₁, normalized MIP level \tilde{m}=m/M, and positional encoding P (x, y) to T^{m}(x, y) texel at coordinate (x,y) of MIP level m. In some aspects, the trained decoder 402 includes fully connected layers with skip connections.

In some aspects, reconstructing a texel of a texture may involve determining whether the second resolution (e.g., the resolution at which the texel is to be reconstructed) is lower than, equal to, or greater than the first resolution (e.g., the resolution of the grid). This determination can be made based on the received level of detail information indicating the second resolution. For example, when the second resolution is determined to be lower than the first resolution, a subset of grid points can be selected from the grid utilizing the sampler 120. The selection of the subset can be performed in response to determining that the second resolution is lower than the first resolution. The subset of grid points can be chosen such that the density of grid points in the subset corresponds to the lower second resolution. For example, if the second resolution is half of the first resolution in each dimension, then the subset may include every other grid point in each dimension. For example, the subset of grid points selected for sampling may be based on a stride level, where the stride level may be based on a ratio between the resolution to render the texture, and the resolution of the grid.

In some aspects, when the second resolution is determined to be equal to the first resolution, no subset selection may be performed, and the grid points can be used directly for sampling. This is because the density of grid points in the original grid already corresponds to the desired output resolution. In some aspects, when the second resolution is determined to be greater than the first resolution, the entire grid may be used for sampling such that the grid points are used for sampling.

### Example Artificial Intelligence System for Performing Graphics Texture Reconstruction

Certain aspects described herein may be implemented, at least in part, using some form of artificial intelligence (AI), e.g., the process of using a machine-learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine-learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine-learning. Further, it should be understood that, unless otherwise specifically stated, terms such “AI model,” “ML model,” “AI/ML model,” “trained ML model,” and the like are intended to be interchangeable.

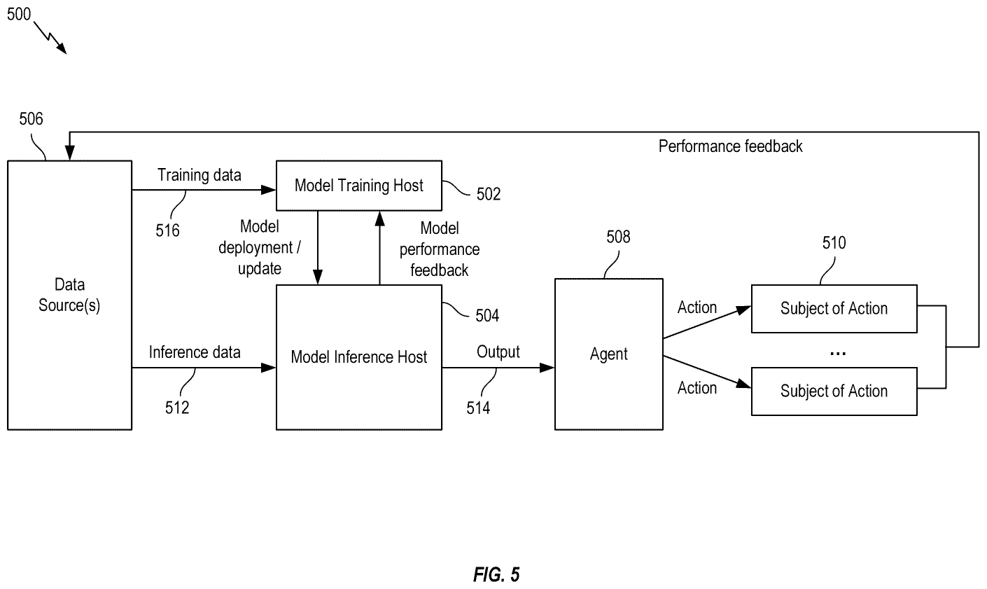

FIG. 5 is a diagram illustrating an example AI architecture 500 that may be used for performing graphics texture reconstruction as described above with respect to FIGS. 1-4. As illustrated in FIG. 5, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508.

The agent 508 may be an element or an entity of a wireless communication system including, for example, a radio access network (RAN), a wireless local area network, a device-to-device (D2D) communications system, etc. As an example, the agent 508 may be a user equipment (UE), a base station or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with texture reconstruction for a 3D scene, the agent 508 may be user equipment that includes a gaming console GPU or a specialized graphics card. As another example, if output 514 from model inference host 504 is associated with a reconstructed texel, the agent 508 may be a rendering engine or a texture management module.

After the agent 508 receives output 514 from the model inference host 504, agent 508 may determine whether to act based on the output. For example, if agent 508 is a rendering engine or a texture management module and the output 514 from model inference host 504 is associated with a reconstructed texel, the agent 508 may determine to discard the reconstructed texel if the location or region associated with the reconstructed texel is occluded. As another example, the agent 508 determines to render the texture, then the agent 508 may provide the texel data to a shading pipeline stage.

The data sources 506 may be configured for collecting data that is used as training data 516 for training an ML model, or as inference data 512 for feeding an ML model inference operation. In particular, the data sources 506 may collect data from any of various entities (e.g., texture maps designed by artists or procedural generation methods), which may include the subject of action 510, and provide the collected data to a model training host 502 for ML model training. For example, after a subject of action 510 (e.g., a shading pipeline) receives a reconstructed texel from agent 508, the subject of action 510 may provide performance feedback associated with the reconstructed texel to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

For example, after a new stone wall texture is compressed by the encoder and decompressed by the decoder, a graphics designer may provide subjective quality feedback to the data sources. If the perceptual quality is below a threshold, the excessive blurriness or blocking artifacts may indicate the decoder model needs retraining to improve reconstruction. In some examples, if the decoder output is inaccurate compared to the source texture, the model training host 502 may determine to fine-tune the model parameters or switch to an enhanced architecture via model update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

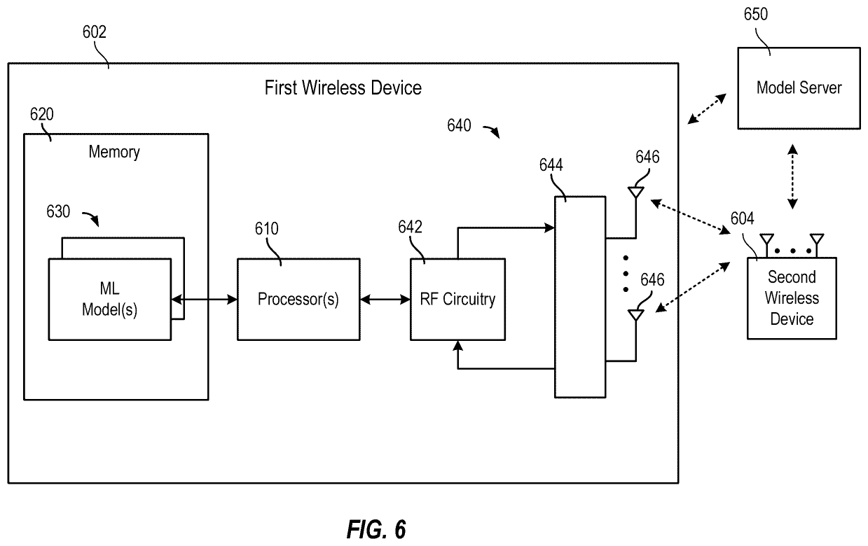

FIG. 6 illustrates an example AI architecture of a first wireless device 602 that is in communication with a second wireless device 604. The first wireless device 602 may be for performing graphics texture reconstruction as described herein with respect to FIGS. 1-5. Similarly, the second wireless device 604 may be for performing graphics texture reconstruction as described herein with respect to FIGS. 1-5. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may generate texel reconstructions corresponding to requested level of detail and coordinate information. The input data may include, for example, one or more grid(s), level of detail, and coordinate location information. The output data may include, for example, reconstructed texel values corresponding to a region of interest of a texture and/or texture set as previously described. Note that other input data and/or output data may be used in addition to or instead of the examples described herein.

In certain aspects, a model server 650 may perform any of various ML model lifecycle management (LCM) tasks for the first wireless device 602 and/or the second wireless device 604. The model server 650 may operate as the model training host 502 of FIG. 5 and update the ML model 630 using training data. In some cases, the model server 650 may operate as the data source 506 of FIG. 5 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine-learning tasks, such as federated learning.

### Example Artificial Intelligence Model

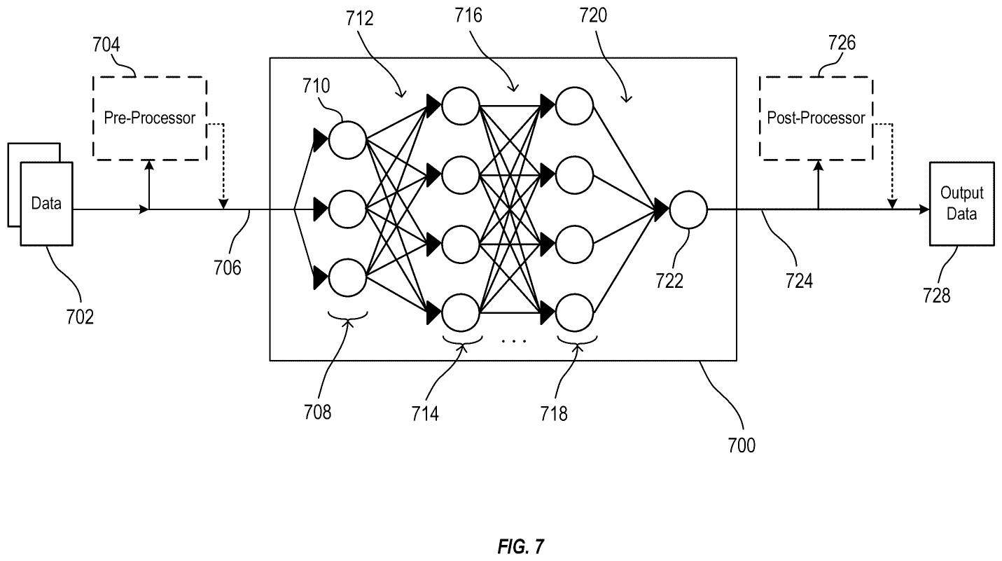

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 6 and 7. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Example Method for Performing 3D Scene Reconstruction

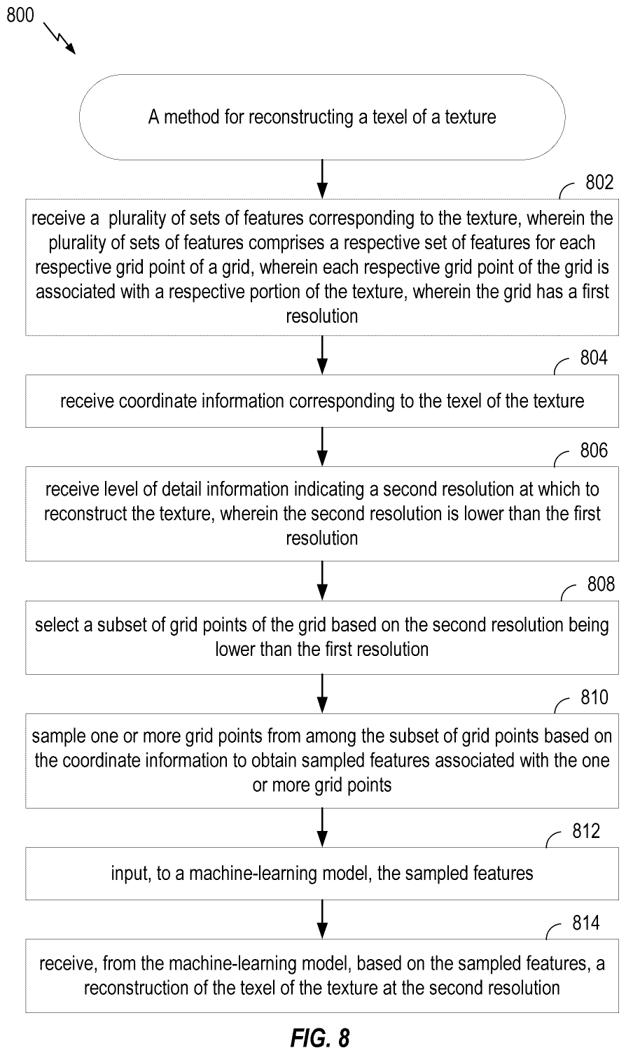

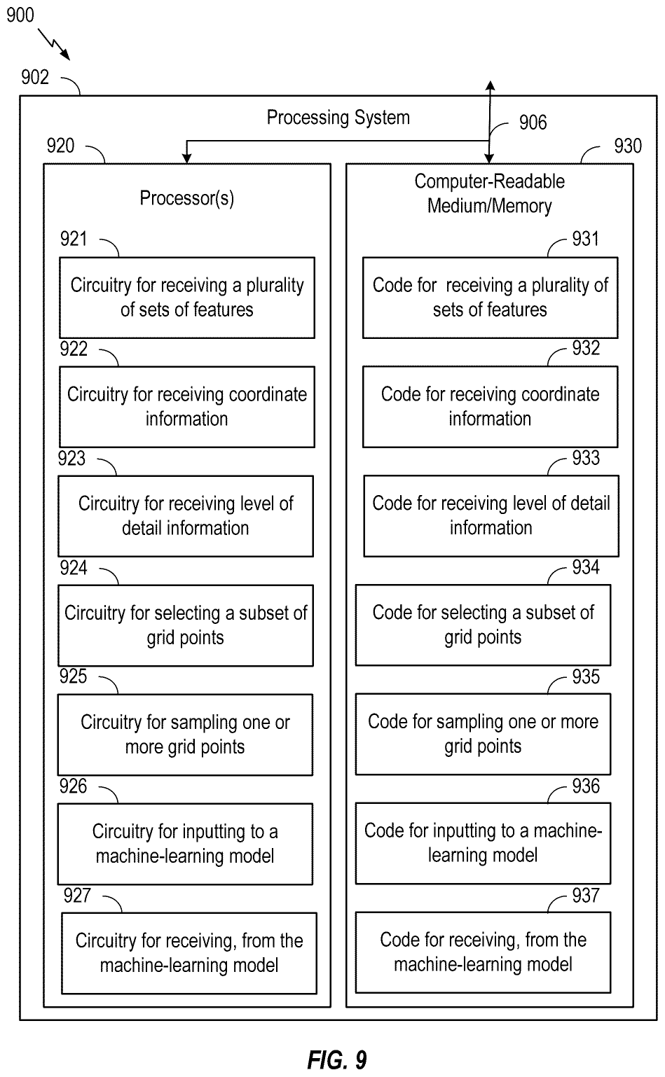

FIG. 8 shows a method 800 for performing graphics texture reconstruction. In one aspect, method 800, or any aspect related to it, may be performed by an apparatus, such as processing system 900 of FIG. 9, which includes various components operable, configured, or adapted to perform the method 800.

Method 800 begins at 802 with receiving a plurality of sets of features corresponding to the texture. In embodiments, the plurality of sets of features comprises a respective set of features for each respective grid point of a grid, wherein each respective grid point of the grid is associated with a respective portion of the texture, wherein the grid has a first resolution.

The method 800 may then proceed to 804 with receiving coordinate information corresponding to the texel of the texture.

The method 800 may then proceed to 806 with receiving level of detail information indicating a second resolution at which to reconstruct the texture, wherein the second resolution is lower than the first resolution.

The method 800 may then proceed to 808 with selecting a subset of grid points of the grid based on the second resolution being lower than the first resolution.

The method may then proceed to 810 with sampling one or more grid points from among the subset of grid points based on the coordinate information to obtain sampled features associated with the one or more grid points.

The method may then proceed to 812 with inputting to a machine-learning model, the sampled features.

The method 800 may then end at 814 with receiving, from the machine-learning model, based on the sampled features, a reconstruction of the texel of the texture at the second resolution.

In some embodiments, method 800 further comprises training an encoder and the machine-learning model using a loss function to adjust weights of the encoder and the machine-learning model; inputting the texture into the encoder; and receiving as output from the encoder the plurality of sets of features.

In some embodiments of method 800, the encoder comprises a convolutional layer.

In some embodiments of method 800, training the encoder and the machine-learning model comprises generating, by the encoder, a first candidate plurality of sets of features; reconstructing, by the machine-learning model, one or more texels, at one or more resolutions, based on the first candidate plurality of sets of features; and adjusting weights of the encoder and the machine-learning model based on the loss function.

In some embodiments of method 800, the plurality of sets of features are quantized to discrete levels.

In some embodiments of method 800, sampling the one or more grid points comprises performing one or more of four nearest neighbor sampling or bilinear sampling.

In some embodiments of method 800, sampling the one or more grid points comprises nearest-neighbor interpolation of the four nearest neighbor sampling.

In some embodiments, method 800 further comprises: receiving a second plurality of sets of features corresponding to the texture, wherein the second plurality of sets of features comprises a respective set of features for each respective grid point of a second grid, wherein each respective grid point of the second grid is associated with a respective portion of the texture, wherein the second grid has the first resolution; sampling the second grid at one or more second grid points to obtain second features associated with the one or more second grid points; and inputting, to the machine-learning model, the second features, wherein receiving, from the machine-learning model the reconstruction of the texel of the texture is further based on the second features.

In some embodiments of method 800, each set of features of the plurality of sets of features comprises a multi-channel feature vector.

In some embodiments, method 800 further comprising: selecting a striding level based on a ratio between the first resolution and the second resolution, wherein selecting the subset of grid points of the grid based on the second resolution being lower than the first resolution comprises selecting the subset of grid points of the grid based on the striding level.

In some embodiments of method 800, the machine-learning model comprises a multilayer perceptron architecture with skip connections.

In some embodiments of method 800, the level of detail information indicates a mipmap level of texture.

In some embodiments of method 800, the reconstruction of the texel comprises texture attributes corresponding to material properties.

In some embodiments of method 800, the coordinate information is encoded as a position-encoding vector based on values of a pair of coordinate variables.

In some embodiments, the method 800 further comprises a modem, coupled to one or more antennas, and coupled to one or more processors, wherein the modem and the one or more antennas are configured to receive the texture.

In some embodiments of method 800, the modem and the one or more antennas are integrated into one of a vehicle, an extra-reality device, or a mobile device.

In some embodiments, method 800 further comprises inputting the texture into an encoder; and receiving, as output from the encoder, a plurality of sets of features corresponding to the texture.

Note that FIG. 8 is just one example of a method, and other methods including fewer, additional, or alternative steps are possible consistent with this disclosure.

### Example Processing System for Performing 3D Scene Reconstruction

FIG. 9 depicts aspects of an example processing system 900.

The processing system 900 includes a processing system 902 includes one or more processors 920. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 800 described with respect to FIG. 8, or any aspect related to it, including any additional steps or sub-steps described in relation to FIG. 8.

In the depicted example, computer-readable medium/memory 930 stores code (e.g., executable instructions) for receiving a plurality of sets of features corresponding to the texture, wherein the plurality of sets of features comprises a respective set of features for each respective grid point of a grid, wherein each respective grid point of the grid is associated with a respective portion of the texture, wherein the grid has a first resolution 931, code for receiving coordinate information corresponding to the texel of the texture 932, code for receiving level of detail information indicating a second resolution at which to reconstruct the texture, wherein the second resolution is lower than the first resolution 933, code for selecting a subset of grid points of the grid based on the second resolution being lower than the first resolution 934; code for sampling one or more grid points from among the subset of grid points based on the coordinate information to obtain sampled features associated with the one or more grid points 935; code for inputting, to a machine-learning model, the sampled features 936; and code for receiving, from the machine-learning model, based on the sampled features, a reconstruction of the texel of the texture at the second resolution 937. Processing of the code 931-937 may enable and cause the processing system 900 to perform the method 800 described with respect to FIG. 8, or any aspect related to it.

The one or more processors 920 include circuitry configured to implement (e.g., execute) the code stored in the computer-readable medium/memory 930, including circuitry for receiving a plurality of sets of features corresponding to the texture, wherein the plurality of sets of features comprises a respective set of features for each respective grid point of a grid, wherein each respective grid point of the grid is associated with a respective portion of the texture, wherein the grid has a first resolution 921, circuitry for receiving coordinate information corresponding to the texel of the texture 922, circuitry for receiving level of detail information indicating a second resolution at which to reconstruct the texture, wherein the second resolution is lower than the first resolution 923, and circuitry for selecting a subset of grid points of the grid based on the second resolution being lower than the first resolution 924, circuitry for sampling one or more grid points from among the subset of grid points based on the coordinate information to obtain sampled features associated with the one or more grid points 925; circuitry for inputting, to a machine-learning model, the sampled features 926; and circuitry for receiving, from the machine-learning model, based on the sampled features, a reconstruction of the texel of the texture at the second resolution 927. Processing with circuitry 921-927 may enable and cause the processing system 900 to perform the method 800 described with respect to FIG. 8, or any aspect related to it.

### EXAMPLE CLAUSES

Implementation examples are described in the following numbered clauses:

Clause 1: A method for reconstructing a texel of a texture, the method comprising: receiving a plurality of sets of features corresponding to the texture, wherein the plurality of sets of features comprises a respective set of features for each respective grid point of a grid, wherein each respective grid point of the grid is associated with a respective portion of the texture, wherein the grid has a first resolution; receiving coordinate information corresponding to the texel of the texture; receiving level of detail information indicating a second resolution at which to reconstruct the texture, wherein the second resolution is lower than the first resolution; selecting a subset of grid points of the grid based on the second resolution being lower than the first resolution; sampling one or more grid points from among the subset of grid points based on the coordinate information to obtain sampled features associated with the one or more grid points; inputting, to a machine-learning model, the sampled features; and receiving, from the machine-learning model, based on the sampled features, a reconstruction of the texel of the texture at the second resolution.

Clause 2: The method of Clause 1, further comprising: training an encoder and the machine-learning model using a loss function to adjust weights of the encoder and the machine-learning model; inputting the texture into the encoder; and receiving as output from the encoder the plurality of sets of features.

Clause 3: The method of Clause 2, wherein the loss function is based on a difference between an output of the machine-learning model and an input to the encoder.

Clause 4: The method of Clause 2, wherein the encoder comprises a convolutional layer.

Clause 5: The method of Clause 2, wherein training the encoder and the machine-learning model comprises: generating, by the encoder, a first candidate plurality of sets of features; reconstructing, by the machine-learning model, one or more texels, at one or more resolutions, based on the first candidate plurality of sets of features; and adjusting weights of the encoder and the machine-learning model based on the loss function.

Clause 6: The method of any one of Clauses 1-5, wherein the plurality of sets of features are quantized to discrete levels.

Clause 7: The method of any one of Clauses 1-6, wherein sampling the one or more grid points comprises performing one or more of four nearest neighbor sampling or bilinear sampling.

Clause 8: The method of Clause 7, wherein sampling the one or more grid points comprises performing nearest-neighbor interpolation of the four nearest neighbor sampling.

Clause 9: The method of any one of Clauses 1-8, further comprising: receiving a second plurality of sets of features corresponding to the texture, wherein the second plurality of sets of features comprises a respective set of features for each respective grid point of a second grid, wherein each respective grid point of the second grid is associated with a respective portion of the texture, wherein the second grid has the first resolution; sampling the second grid at one or more second grid points to obtain second features associated with the one or more second grid points; and inputting, to the machine-learning model, the second features, wherein receiving, from the machine-learning model the reconstruction of the texel of the texture is further based on the second features.

Clause 10: The method of any one of Clauses 1-9, wherein each set of features of the plurality of sets of features comprises a multi-channel feature vector.

Clause 11: The method of any one of Clauses 1-10, further comprising: selecting a striding level based on a ratio between the first resolution and the second resolution, wherein selecting the subset of grid points of the grid based on the second resolution being lower than the first resolution comprises selecting the subset of grid points of the grid based on the striding level.

Clause 12: The method of any one of Clauses 1-11, wherein the machine-learning model comprises a multilayer perceptron architecture with skip connections.

Clause 13: The method of any one of Clauses 1-12, wherein the level of detail information indicates a mipmap level of texture.

Clause 14: The method of any one of Clauses 1-13, wherein the reconstruction of the texel comprises texture attributes corresponding to material properties.

Clause 15: The method of any one of Clauses 1-14, wherein the coordinate information is encoded as a position-encoding vector based on values of a pair of coordinate variables.

Clause 16: The method of any one of Clauses 1-15, wherein the method is performed by an apparatus comprising a modem, coupled to one or more antennas, and coupled to one or more processors, wherein the modem and the one or more antennas are configured to receive the texture.

Clause 17: The method of Clause 16, wherein the modem and the one or more antennas are integrated into one of a vehicle, an extra-reality device, or a mobile device.

Clause 18: The method of any one of Clauses 1-17, further comprising: inputting the texture into an encoder; and receiving, as output from the encoder, the plurality of sets of features corresponding to the texture.

Clause 19: The method of Clause 1, wherein the machine-learning model is trained using an encoder and a loss function to adjust weights of the encoder and the machine-learning model.

Clause 20: The method of Clause 19, wherein the loss function is based on a difference between an output of the machine-learning model and an input to the encoder.

Clause 21: The method of Clause 19, wherein the encoder comprises a convolutional layer.

Clause 22: The method of Clause 19, wherein the encoder and the machine-learning model are trained using a first candidate plurality of sets of features, wherein one or more texels are reconstructed at one or more resolutions based on the first candidate plurality of sets of features, and wherein the weights of the enconder and the machine-learning model are adjusted based on the loss function.

Clause 23: The method of Clause 1, wherein the machine-learning model is trained using an encoder performing multiple iterations across multiple resolutions.

Clause 24: The method of Clause 1, wherein the machine-learning model is trained using an autoencoder comprising an encoder model and a decoder model, the autoencoder being trained by: compressing, using the encoder model, an input texture into a latent representation comprising a plurality of sets of features corresponding to grid points; reconstructing, using the decoder model, texels of the input texture from the latent representation; comparing the reconstructed texels to original texels of the input texture using a loss function; and updating weights of the encoder model and the decoder model based on gradients of the loss function.

Clause 25: The method of Clause 1, further comprising: receiving a second plurality of sets of features corresponding to the texture, wherein the second plurality of sets of features comprises a respective set of features for each respective grid point of a second grid, wherein each respective grid point of the second grid is associated with a respective portion of the texture; receiving level of detail information indicating a second resolution at which to reconstruct the texel; determining whether the second resolution is lower than, equal to, or greater than the first resolution; in response to determining that the second resolution is lower than the first resolution, selecting a subset of grid points of the grid; sampling one or more grid points of the subset of grid points based on the coordinate information to obtain features associated with the one or more grid points, wherein the one or more grid points are selected from the subset of grid points if the second resolution is lower than the first resolution; sampling the second grid at the one or more second grid points to obtain second features associated with the one or more second grid points; and inputting, to the machine-learning model, the second features, wherein receiving, from the machine-learning model the reconstruction of the texel of the texture is further based on the second features.

Clause 26: The method of Clause 1, further comprising: receiving a second plurality of sets of features corresponding to the texture, wherein the second plurality of sets of features comprises a respective set of features for each respective grid point of a second grid, wherein each respective grid point of the second grid is associated with a respective portion of the texture, wherein the second grid has a third resolution; sampling the second grid at one or more second grid points to obtain second features associated with the one or more second grid points; and inputting, to the machine-learning model, the second features, wherein receiving, from the machine-learning model the reconstruction of the texel of the texture is further based on the second features.

Clause 27: The method of Clause 26, wherein the third resolution is the same as the first resolution.

Clause 28: The method of Clause 26, wherein the third resolution is different from the first resolution.

Clause 29: One or more apparatuses, comprising: one or more memories comprising executable instructions; and one or more processors configured to execute the executable instructions and cause the one or more apparatuses to perform a method in accordance with any one of Clauses 1-28.

Clause 30: One or more apparatuses, comprising: one or more memories; and one or more processors, coupled to the one or more memories, configured to cause the one or more apparatuses to perform a method in accordance with any one of Clauses 1-28.

Clause 31: One or more apparatuses, comprising: one or more memories; and one or more processors, coupled to the one or more memories, configured to perform a method in accordance with any one of Clauses 1-28.

Clause 32: One or more apparatuses, comprising means for performing a method in accordance with any one of Clauses 1-28.

Clause 33: One or more non-transitory computer-readable media comprising executable instructions that, when executed by one or more processors of one or more apparatuses, cause the one or more apparatuses to perform a method in accordance with any one of Clauses 1-28.

Clause 34: One or more computer program products embodied on one or more computer-readable storage media comprising code for performing a method in accordance with any one of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising:
one or more memories; and
one or more processors, coupled to the one or more memories, configured to:
receive a plurality of sets of features corresponding to a texture, wherein the plurality of sets of features comprises a respective set of features for each respective grid point of a grid, wherein each respective grid point of the grid is associated with a respective portion of the texture, wherein the grid has a first resolution;
receive coordinate information corresponding to a texel of the texture;
receive level of detail information indicating a second resolution at which to reconstruct the texture, wherein the second resolution is lower than the first resolution;
select a subset of grid points of the grid based on the second resolution being lower than the first resolution;
sample one or more grid points from among the subset of grid points based on the coordinate information to obtain sampled features associated with the one or more grid points;
input, to a machine-learning model, the sampled features; and
receive, from the machine-learning model, based on the sampled features, a reconstruction of the texel of the texture at the second resolution.

2. The apparatus of claim 1, wherein the one or more processors are configured to:
train an encoder and the machine-learning model using a loss function to adjust weights of the encoder and the machine-learning model;
input the texture into the encoder; and
receive as output from the encoder the plurality of sets of features.

3. The apparatus of claim 2, wherein the loss function is based on a difference between an output of the machine-learning model and an input to the encoder.

4. The apparatus of claim 2, wherein the encoder comprises a convolutional layer.

5. The apparatus of claim 2, wherein to train the encoder and the machine-learning model comprises to:
generate, by the encoder, a first candidate plurality of sets of features;
reconstruct, by the machine-learning model, one or more texels, at one or more resolutions, based on the first candidate plurality of sets of features; and
adjust weights of the encoder and the machine-learning model based on the loss function.

6. The apparatus of claim 1, wherein the plurality of sets of features are quantized to discrete levels.

7. The apparatus of claim 1, wherein to sample the one or more grid points comprises to perform one or more of four nearest neighbor sampling or bilinear sampling.

8. The apparatus of claim 7, wherein to sample the one or more grid points comprises to perform nearest-neighbor interpolation of the four nearest neighbor sampling.

9. The apparatus of claim 1, wherein the one or more processors are configured to:
receive a second plurality of sets of features corresponding to the texture, wherein the second plurality of sets of features comprises a respective set of features for each respective grid point of a second grid, wherein each respective grid point of the second grid is associated with a respective portion of the texture, wherein the second grid has the first resolution;
sample the second grid at one or more second grid points to obtain second features associated with the one or more second grid points; and
input, to the machine-learning model, the second features, wherein to receive, from the machine-learning model the reconstruction of the texel of the texture is further based on the second features.

10. The apparatus of claim 1, wherein each set of features of the plurality of sets of features comprises a multi-channel feature vector.

11. The apparatus of claim 1, wherein the one or more processors are configured to:
select a striding level based on a ratio between the first resolution and the second resolution, wherein to select the subset of grid points of the grid based on the second resolution being lower than the first resolution comprises to select the subset of grid points of the grid based on the striding level.

12. The apparatus of claim 1, wherein the machine-learning model comprises a multilayer perceptron architecture with skip connections.

13. The apparatus of claim 1, wherein the level of detail information indicates a mipmap level of texture.

14. The apparatus of claim 1, wherein the reconstruction of the texel comprises texture attributes corresponding to material properties.

15. The apparatus of claim 1, wherein the coordinate information is encoded as a position-encoding vector based on values of a pair of coordinate variables.

16. The apparatus of claim 1, further comprising a modem, coupled to one or more antennas, and coupled to the one or more processors, wherein the modem and the one or more antennas are configured to receive the texture.

17. The apparatus of claim 16, wherein the modem and the one or more antennas are integrated into one of a vehicle, an extra-reality device, or a mobile device.

18. The apparatus of claim 1, wherein the one or more processors are configured to:
input the texture into an encoder; and
receive, as output from the encoder, the plurality of sets of features corresponding to the texture.

19. A method for reconstructing a texel of a texture, the method comprising:
receiving a plurality of sets of features corresponding to the texture, wherein the plurality of sets of features comprises a respective set of features for each respective grid point of a grid, wherein each respective grid point of the grid is associated with a respective portion of the texture, wherein the grid has a first resolution;
receiving coordinate information corresponding to the texel of the texture;
receiving level of detail information indicating a second resolution at which to reconstruct the texture, wherein the second resolution is lower than the first resolution;
selecting a subset of grid points of the grid based on the second resolution being lower than the first resolution;
sampling one or more grid points from among the subset of grid points based on the coordinate information to obtain sampled features associated with the one or more grid points;
inputting, to a machine-learning model, the sampled features; and
receiving, from the machine-learning model, based on the sampled features, a reconstruction of the texel of the texture at the second resolution.

20. The method of claim 19, further comprising:
training an encoder and the machine-learning model using a loss function to adjust weights of the encoder and the machine-learning model;
inputting the texture into the encoder; and
receiving as output from the encoder the plurality of sets of features.
